(19) United States
(12) Patent Application Publication
(10) Pub. No.: US 2006/0234612 A1
(43) Pub. Date: Oct. 19, 2006

(54) Vehicle lamp with a light guide of a multi-member configuration

(75) Inventor: Frank Gotthardt, Goettingen (DE)

Correspondence Address: SUGHRUE MION, PLLC, 2100 PENNSYLVANIA AVENUE, N.W., SUITE 800, WASHINGTON, DC, 20037, US

(73) Assignee: FER Fahrzeugelektrik GmbH

(21) Appl. No.: 11/277,415

(22) Filed: Mar. 24, 2006

(30) Foreign Application Priority Data
Mar. 29, 2005 (DE) 10 2005 014 195.1
Apr. 25, 2005 (DE) 10 2005 019 093.6

(51) Int. Cl. A22B 3/06

(52) U.S. Cl. 452/58

(57) ABSTRACT

The invention concerns a vehicle lamp comprising an elongate light guide, and a light source which is arranged at one end of the light guide and whose light is coupled into the light guide and at least partially passed to an oppositely disposed coupling-out end where it is coupled-out. The light guide is of a multi-member configuration and on the side towards the vehicle has a plurality of limbs which are curved to differing degrees.

### CROSS-REFERENCES TO RELATED APPLICATIONS

This application claims the priorities of German patent applications Serial Nos 10 2005 014 195.1 filed Mar. 29, 2005 and 10 2005 019 093.6 filed Apr. 25, 2005, the subject-matter of which is incorporated herein by reference.

### FIELD OF THE INVENTION

The invention relates to a vehicle lamp with an elongate light guide and a light guide for a lamp.

### BACKGROUND OF THE INVENTION

Bar-shaped light guides are frequently used in vehicle lamps such as for example side marking or riding lamps or side flashing lamps which are integrated into the external mirror of vehicles. They enjoy in particular the advantage that the desired light distribution can be implemented using relatively simple means and very inexpensively.

The structure and function of a typical vehicle lamp with a bar-shaped light guide are described in greater detail hereinafter with reference to FIGS. 1 and 2. FIG. 1 shows a side flashing lamp 4 which is known from the state of the art and which is integrated in the external rear view mirror 1 of a motor vehicle. The left-hand side of the mirror 1 is towards a vehicle in the installed position thereof. In the present case the side flashing lamp 4 includes two bar-shaped light guides 5, 5′ which are arranged in parallel superposed relationship and which extend substantially horizontally in the installed position. The light emitted by the light guides 5, 5′ passes on the one hand outwardly, that is to say in the position of being installed on a vehicle forwardly in the direction of travel, through a light exit opening 3 provided in the cover cap 2 of the mirror 1, while on the other hand it is coupled out at the ends 7 of the light guides 5, 5′in a lateral direction from the vehicle.

FIG. 2 shows a view in section taken along line II-II in FIG. 1. As can be seen therefrom, arranged at the end 10 of the light guides 5, 5′, which is therefore the vehicle end, are light emitting diodes 11 whose light is coupled into the light guides 5, 5′ and is passed almost completely by total reflection at the interfaces to the oppositely disposed outward end 7. The end 7 has a bevelled coupling-out surface 8 whose inclination is so selected that the light which issues is emitted into the solid angular region which is prescribed by relevant regulations, that is to say substantially transversely with respect to the direction of travel of the vehicle and somewhat inclinedly rearwardly, as is indicated by the arrows F. The light emission region is determined by the direction of the light guide at the coupling-out end 7 and the inclination of the bevelled surface 8.

In many external rear view mirrors the configuration of the light guide 5 is restricted by the configuration of the cover cap 2 and the installation space which is predetermined thereby. In such cases, for reasons relating to structural technology, it is not possible to fit a more greatly curved light guide 5 whose coupling-out end 7 points inclinedly rearwardly. It is therefore necessary to use a light guide which extends in a relatively straight line and the coupling-out end of which extends substantially in a lateral direction. Admittedly, by implementing optical measures such as for example bevelling at the coupling-out end, it is possible to influence the direction of the light beams which are coupled out, but that can be done only to a slight degree. If the bevelled coupling-out surface is inclined to an excessively great degree, the light beams impinge on the coupling-out surface above the total reflection angle and are reflected thereby and are not coupled-out. Light emission in particular inclinedly rearwardly, as is required by the statutory regulations, therefore cannot be achieved.

### SUMMARY OF THE INVENTION

An object of the present invention is to provide a vehicle lamp having an elongate light guide, the coupling-out end of which points substantially in a lateral direction and from which light can nonetheless be emitted into a spatial region which complies with the relevant regulations.

Another object of the present invention is to provide a vehicle lamp affording improved light emission characteristics in terms of direction and spread angle.

A further object of the invention is to provide a vehicle lamp with integrated light guide means and operable to afford enhanced light output of a desired configuration.

Still a further object of the invention to provide a light guide for a lamp such as a vehicle lamp, which can be effective to produce light emission of a respectively desired configuration in a desired directional space.

In accordance with the invention the foregoing and other objects are attained by a vehicle lamp, for example for installation in vehicle bodywork or a cover cap of an external rear view mirror, comprising an elongate light guide and a light source which is arranged at one end of the light guide. Light from the light source is coupled into the light guide and at least partially passed to an oppositely disposed coupling-out end and there coupled-out. The light guide is of a multi-member configuration and has a plurality of limbs which are curved to differing degrees.

Also in accordance with the invention the foregoing and other objects are attained by a light guide, for example for installation in a vehicle lamp, which is of an elongate shape and which serves to pass light which is introduced at one end to an oppositely disposed end at which it is coupled out. The light guide is of a multi-member configuration and has a plurality of limbs which are curved to differing degrees. Further configurations of the invention are the subject-matter of appendant claims.

As will be seen from the description hereinafter of preferred embodiments of the invention the light guide of the vehicle lamp is of a multi-member configuration, that is to say having a plurality of limbs which preferably extend in mutually juxtaposed relationship and which are curved to differing degrees. In that case the light is preferably introduced in end relationship at the individual coupling-in ends of the limbs. The differing curvature results in a different beam path in each of the limbs, whereby the light beams impinge at different angles of incidence on the side and coupling-out surfaces of the light guide. The multi-member configuration therefore affords a substantial advantage in that the light guided in the light guide involves very different directions and is thus also coupled out in very different directions at the coupling-out surface. In that way it is now possible for the light to be emitted in a relatively wide solid angle which complies with the relevant regulations, even if the coupling-out end of the light guide extends substantially in a lateral direction. The angular range in which the light is emitted is determined in particular by the curvature of the individual limbs and can be adjusted in the desired manner.

In a preferred feature of the invention the individual limbs of the light guide in the installation position are disposed in the same horizontal plane and are preferably curved about a vertical axis to differing degrees.

In accordance with a preferred feature of the invention the individual limbs extend in convergent relationship and blend into each other in a wedge-shaped configuration. The individual limbs can preferably communicate with a single common light guide portion, at the end of which is provided a common coupling-out surface.

In accordance with another preferred feature of the invention the individual limbs can extend in convergent relationship and pass through each other. In that case the light guide has a plurality of coupling-out surfaces which are arranged in displaced relationship in the longitudinal direction, constituting a light guide direction.

The light guide is preferably of a one-piece configuration.

In another preferred feature the individual limbs are of differing lengths, wherein a more heavily curved limb is preferably shorter than a less heavily curved limb.

In accordance with a preferred feature of the invention the light guide has precisely three limbs. That structure exhibits sufficiently good light distribution at the coupling-out end, while being of the smallest possible structural depth.

Preferably a light source such as for example an LED is arranged at each end of a limb, the light from the light source being coupled into the light guide.

In order to boost the coupling-out effect of light in the direction of travel of a vehicle to which the lamp is fitted the light guide can have light-diffusing means at a longitudinal side. Thus for example the surface of the rearward longitudinal side can be of a particularly rough nature. Alternatively other diffusing structures could also be provided at the rear side of the light guide.

Preferably an optical means can be provided at the coupling-in end of the limbs, by way of which optical means the beam configuration in the light guide can be influenced. That optical means is preferably embodied by the coupling-in end of the limbs being of an optically operative configuration, but it can also be provided outside the light guide. The coupling-in end can be for example of a spherical, convex or concave shape. By matching the coupling-in optical means and the curvature of the individual limbs, it is possible to adjust as desired the beam configuration in the light guide and thus the region into which the light is coupled out. Additionally or alternatively it is also possible for optical means such as for example a bevelling of the coupling-out surface to be provided at the coupling-out end. Once again the light emission region can be influenced by suitably selecting the inclination of the coupling-out surface.

A preferred feature of the invention provides that the cross-section of the individual limbs is round but it can also be elliptical or rectangular or can be of another shape. When the cross-section is rectangular the light guide can be considered for example as being plate-shaped.

The light sources arranged at the ends of the individual limbs are preferably connected in series. Particularly in the case of LEDs, that has the advantage that an unnecessarily high series resistor does not have to be used upstream of each LED. The light sources are also preferably arranged on the same circuit board with a flexible circuit board being particularly suitable in that connection.

Further objects, features and advantages of the invention will be apparent from the description hereinafter of preferred embodiments thereof.

### BRIEF DESCRIPTION OF THE DRAWINGS

FIG. 1 shows a rear view of a typical external rear view mirror for a motor vehicle with an integrated side flashing lamp,

FIG. 2 is a view in section taken along line II-II in FIG. 1,

FIG. 3 is a plan view of a light guide formed by a multi-member structure in accordance with a first embodiment of the invention,

FIG. 4 is a plan view of a light guide formed by a multi-member structure in accordance with a second embodiment of the invention,

FIG. 5 is a plan view of a light guide formed by a multi-member structure in accordance with a third embodiment of the invention, having a plurality of coupling-out surfaces, and

FIG. 6 is a plan view in section of a flashing lamp integrated in the fender, with a light guide of a multi-member configuration.

### DESCRIPTION OF PREFERRED EMBODIMENTS

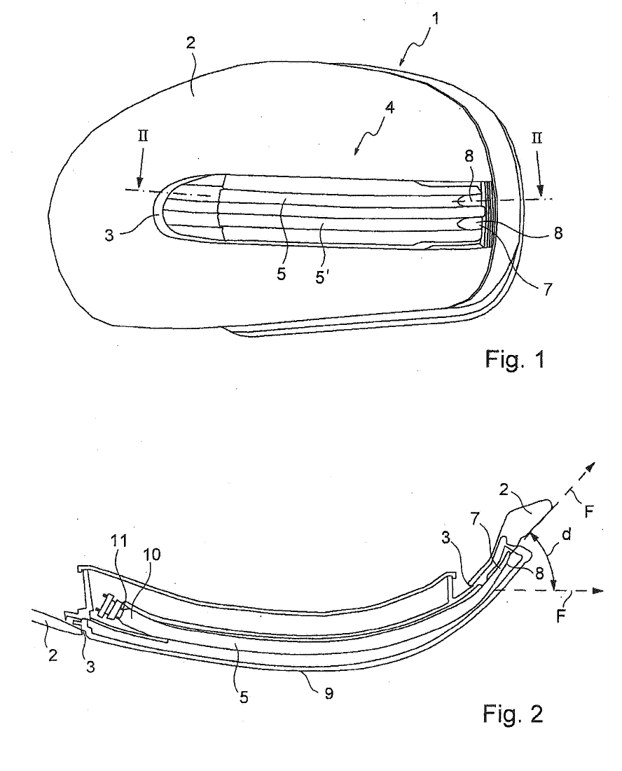

With regard to the description of FIGS. 1 and 2, attention is directed to the introductory part of this description set forth hereinbefore.

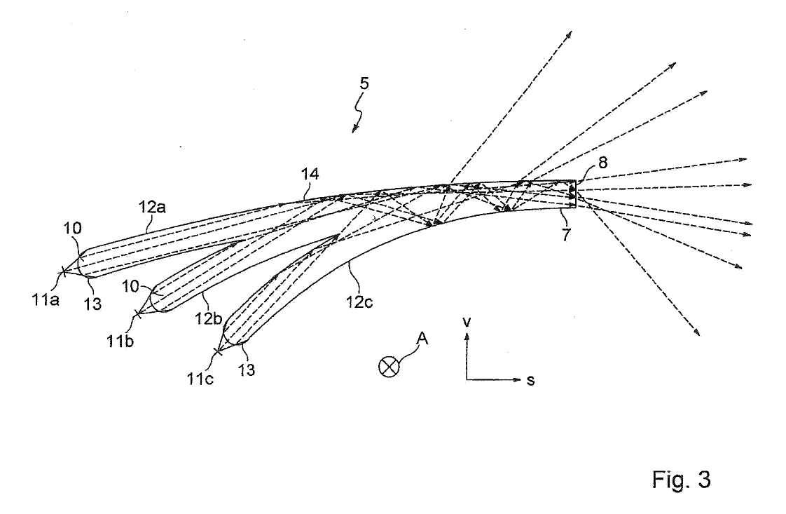

Referring now to FIG. 3, shown therein is a plan view from above of a multi-member integrally formed light guide 5 which for example can be fitted in a side flashing lamp of an external rear view mirror or in a side riding lamp of a vehicle. The light guide 5 can be made as is usually the case from a plastic material. The lamp for that purpose can have mounting means for installation thereof in vehicle bodywork or in a cover cap of an external rear view mirror of a vehicle.

The relative position of the vehicle is indicated by the arrows V, S, wherein V indicates a forward direction of the vehicle and S indicates a lateral direction of the vehicle. The side of the light guide 5, which is towards the vehicle, is the side which is at the left in the Figure.

At the vehicle side the light guide 5 includes three limbs 12a-12c which are arranged in the same horizontal plane, in the installation position. In this case the three limbs 12a-12c are curved about a vertical axis A to differing degrees. In this arrangement the limb 12a which is at the front in the direction of travel V is curved less greatly than the further rearwardly disposed limbs 12b and 12c. The limb 12c is also shorter than the limb 12b and the latter in turn is shorter than the limb 12a.

The individual limbs 12a-12c extend in convergent relationship and blend into a common portion in a wedge-shaped configuration. Arranged at the ends 10 of each of the limbs 12a-12c is a respective LED 11a-11c, the light of which is coupled into the light guide 5. The coupling-in ends 10 of the limbs 12a-12c are of a spherical configuration and as a result have a light-parallelising action.

The light which is coupled in at the coupling-in ends 10 firstly extends approximately parallel within the light guide 5 until it encounters an interface where it is reflected by total reflection. The configuration of some light beams is illustrated by way of example. The differing curvatures of the individual limbs 12a-12c give different angles of incidence and reflection. As a result, at the coupling-out end 7 light beams encounter the coupling-out surface 8 in greatly different directions and are thus emitted into a large solid angle region, both in a lateral direction and also laterally rearwardly.

In the present embodiment the cross-section of the individual limbs 12a-12c is round but it can also be of any other shape.

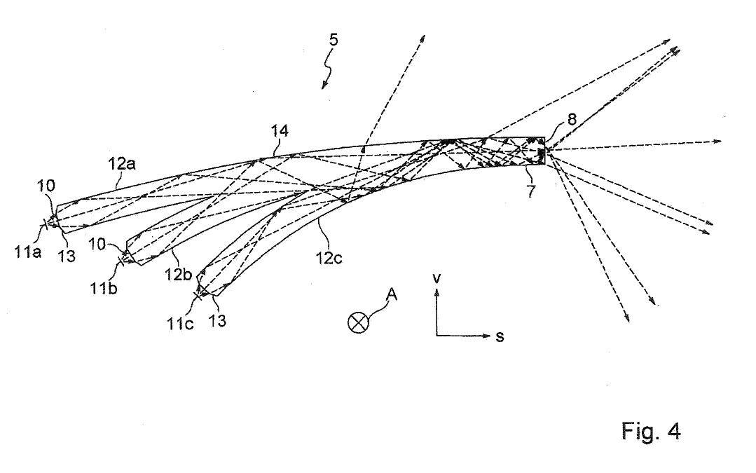

Looking at FIG. 4 this shows a similar embodiment of a multi-member light guide 5 which is of substantially the same structural configuration as that shown in FIG. 3 so that a full repeat of the description thereof at this juncture is not required, the description relating to FIG. 3 being incorporated here by reference as appropriate. Unlike the embodiment of FIG. 3 the optically operative structures 13 which are in opposite relationship to the LEDs 11a-11c are not of a spherical shape but are only slightly convexly curved. That affords within the limbs 12a-12c a non-parallel beam configuration which results in a rather different light emission characteristic at the coupling-out end 7. The size and the position of the light emission region at the end 7 of the light guide 5 can be adjusted by matching as between the curvature of the individual limbs 12a-12c and the configuration of the coupling-in optical means 13, in the desired manner.

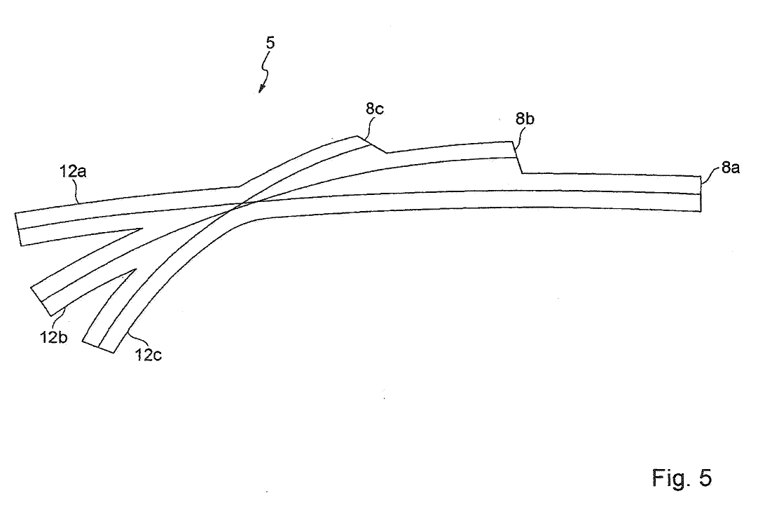

FIG. 5 shows another embodiment of a light guide 5 which is of a multi-member configuration and in which the individual limbs 12a-12c pass into each other and pass through each other. The individual limbs 12a-12c are once again curved about a vertical axis A to differing degrees, with the limb 12c being curved more greatly than the limbs 12b and 12a respectively. The most heavily curved limb 12c is also shorter than the limbs 12b and 12a respectively. As a result the light guide 5 has three coupling-out surfaces 8a, 8b and 8c which are spaced from each other in the longitudinal direction. The coupling-out surfaces 8a-8c can be inclined at different angles.

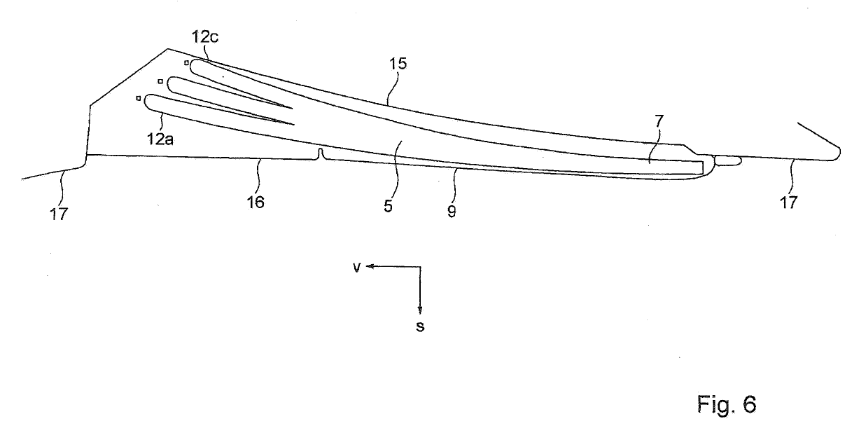

FIG. 6 shows a lamp which is integrated in the fender 17 of a vehicle and which has a light guide 6 as is illustrated in FIG. 3. This side lamp includes a lamp housing 15 which is fixed in the fender bodywork 17 by means of a latching device. The light guide 5 which is integrated in the lamp housing 15 is arranged in such a way that the limbs 12a-12c point approximately in the forward direction V and the coupling-out end 7 points in the rearward direction. The lamp housing 15 is preferably of a one-piece configuration and includes a transparent light exit cover 9 which is arranged in front of the one-piece portion of the light guide 5 and which permits the emission of light in a lateral direction S and also rearwardly. In contrast provided at the front portion, which is of a multi-member configuration, of the light guide 5 is an opaque shield 16 which screens the light in that region. The lamp housing 15 is arranged recessed in the bodywork opening for the major part and projects outwardly beyond the bodywork 17 only in the region of the coupling-out end 7.

It will be seen therefore that in an installation position in which the coupling-out end 7 of the light guide extends substantially in the lateral direction (S) the light can be coupled out to a sufficient degree rearwardly in opposite relationship to the direction of vehicle forward travel by virtue of the light guide being of the multi-portion structure and on the side towards the vehicle having the plurality of limbs 12a-12cwhich are curved to differing degrees.

It will be appreciated that the above-described embodiments of the invention have been set forth solely by way of example and illustration of the principles of the invention and that various other modifications and alterations may be made therein without thereby departing from the scope of the appended claims.

What is claimed is:

1. In a vehicle lamp comprising
an elongate light guide having a first end and a second end, and
a light source at the first end of the light guide and operable to couple its emitted light into the light guide, the light guide being adapted to at least partially pass said light to said second oppositely disposed end at which said light is coupled-out,
the improvement that
the light guide is of a multi-member configuration and has a plurality of limbs which are curved to differing degrees.

2. A vehicle lamp as set forth in claim 1
wherein the limbs of the light guide in the installation position are curved to differing degrees about a vertical axis.

3. A vehicle lamp as set forth in claim 1
wherein the individual limbs are in the same plane in the installation position.

4. A vehicle lamp as set forth in claim 1 comprising
a respective light source arranged at the first end of each said limb and operable to emit its light into the light guide.

5. A vehicle lamp as set forth in claim 1
wherein the individual limbs extend in convergent relationship and pass into each other in a wedge configuration.

6. A vehicle lamp as set forth in claim 5
wherein the limbs communicate with a common portion which at its end forming said second end has a common coupling-out surface.

7. A vehicle lamp as set forth in claim 1
wherein the light guide has three said limbs.

8. A vehicle lamp as set forth in claim 1
wherein the limbs pass into each other and pass through each other so that the light guide has a plurality of coupling-out surfaces arranged in displaced relationship in the longitudinal direction.

9. A vehicle lamp as set forth in claim 1
wherein the light guide has light-diffusing means at a longitudinal side.

10. A vehicle lamp as set forth in claim 1
wherein the first coupling-in end of the limbs is of an optically operative nature.

11. A vehicle lamp as set forth in claim 10
wherein said first coupling-in end of the limbs is convexly shaped.

12. A vehicle lamp as set forth in claim 4
wherein the light sources are connected in series.

13. A vehicle lamp as set forth in claim 1
wherein the limbs of the light guide are of a bar-shaped configuration.

14. A vehicle lamp as set forth in claim 1
wherein the limbs of the light guide are of a plate-shaped configuration.

15. A vehicle lamp as set forth in claim 1 comprising
a circuit board on which all light sources are mounted.

16. A vehicle lamp as set forth in claim 1 including
means for installation thereof in bodywork of a vehicle.

17. A vehicle lamp as set forth in claim 1 including
means for installation thereof in a cover cap of an external rear view mirror of a vehicle.

18. A light guide which is of an elongate shape having first and second ends and which is operable to pass light introduced at the first end to the oppositely disposed second end at which it is coupled-out, the light guide being of a multi-member configuration and comprising a plurality of limbs which are curved to differing degrees.
